(19) United States
(12) Patent Application Publication
(10) Pub. No.: US 2011/0268949 A1
(43) Pub. Date: Nov. 3, 2011

(54) Binder for Mineral Fiber Mats

(75) Inventors: Pia Beate Deindorfer, Burghausen (DE); Holger Poths, Burghausen (DE); Frank Rindfleisch, Burghausen (DE)

(73) Assignee: Wacker Chemie AG, Munich (DE)

(21) Appl. No.: 13/120,886

(22) PCT Filed: Sep. 15, 2009
(86) PCT No.: PCT/EP2009/061967

§ 371 Date: May 19, 2011

(30) Foreign Application Priority Data
Sep. 26, 2008 (DE) 10 2008 042 407.2

(51) Int. Cl. B32B 3/00; B32B 5/02

(52) U.S. Cl. 428/220; 442/59

(57) ABSTRACT

The object of the invention are mineral fiber mats based on mineral fibers and one or more binders, characterized in that at least one binder is a vinyl ester-ethylene copolymer.

### CROSS REFERENCE TO RELATED APPLICATIONS

This application is the national phase filing of international patent application No. PCT/EP2009/061967, filed 15 Sep. 2009, and claims priority of German patent application number 10 2008 042 407.2, filed 26 Sep. 2008, the entireties of which applications are incorporated herein by reference.

### FIELD OF THE INVENTION

The present invention relates to mineral fiber mats based on mineral fibers and binders, processes for producing the mineral fiber mats and mineral fiber reinforced plastics structural parts obtainable therewith, for example for boat hulls, swimming pools or tanks.

### BACKGROUND OF THE INVENTION

Mineral fibers are widely used for reinforcing plastics structural parts. Mineral fiber reinforced plastics structural parts are produced by curing compositions containing curable resin compositions and mineral fibers, for example in the form of mineral fiber mats. Curable resin compositions are liquid or liquefiable compositions and typically comprise reactive resins, such as polyester or epoxy resins, and also, optionally, reactive solvents, usually styrene. Mineral fibers are long, thin fibers based on minerals, i.e., inorganic substances such as glass fibers for example. The individual mineral fibers can have been processed into mineral fiber bundles about 10 to 25 μm in thickness. To facilitate handleability, mineral fibers are frequently processed into mineral fiber mats. In the mineral fiber mats, the individual mineral fibers or mineral fiber bundles are pinned together, via a binder, at contact points of fibers. Mineral fiber mats constitute a flexible, orderless textile fabric which is formed of mineral fibers or mineral fiber bundles and which, if required, can be adapted to the surface contour or shape desired in the particular use scenario. In the course of the production of mineral fiber reinforced plastics structural parts, the textile fabric of the mineral fiber mats disintegrates in the curable resin compositions, so that finally essentially individual, i.e., unbound, mineral fibers are present.

Mineral fiber mat binders frequently utilize vinyl acetate homopolymers which contain plasticizer(s). Common plasticizers are dioctyl phthalate or polymers based on adipic acid for example.

The use of such plasticizers is deprecated today for various reasons. There are workplace safety reasons why the use of plasticizers is viewed critically. In addition, plasticizers in mineral fiber mats are known to have a tendency to migrate, as a result of which the properties of corresponding mineral fiber mats can change over time in respect of flexibility or strength for example. Since the migration of plasticizers is temperature dependent, the individual components for producing the mineral fiber mats have to be specifically conformed to the climatic conditions prevailing at the particular manufacturing site at the particular time of the year. Moreover, the egress of plasticizers from the mineral fiber mats renders the surface thereof tacky and contaminates the environment. Finally, what is more, cost-intensive starting materials are required to synthesize the common plasticizers for mineral fiber mats.

Against this background, the problem was that of providing mineral fiber mat binders having none of the abovementioned issues due to plasticizers.

### SUMMARY OF THE INVENTION

The problem was solved by using vinyl ester-ethylene copolymers as binders for mineral fiber mats.

The basic fact—vinyl ester polymers can be internally plasticized by interpolymerization of ethylene—is known from EP-A 0959114 for example. What was surprising, however, is the discovery that using vinyl ester-ethylene copolymers as binders makes it possible to fulfill the stipulated performance criteria for mineral fiber mats and also to dispense with additional plasticizers.

### DETAILED DESCRIPTION OF THE INVENTION

The present invention provides mineral fiber mats based on mineral fibers and one or more binders, characterized in that at least one binder is a vinyl ester-ethylene copolymer.

The mineral fiber mats are preferably from 0.5 to 5 mm, more preferably from 1 to 3 mm and most preferably from to 2 mm in thickness (determined as per EN 29073 Part 2).

Mineral fibers are known to be essentially inorganic in nature, comprising fibers of metal oxides or semimetal oxides, for example silicon oxide, aluminum oxide, iron oxide, alkali metal oxide or alkaline earth metal oxide. The mineral fibers known as glass fibers, basalt fibers or ceramic fibers are particularly preferable. Glass fibers are most preferable.

Mineral fibers can be continuous mineral fibers or preferably cut mineral fibers. Continuous mineral fibers preferably are at least 15 cm in length. Cut mineral fibers are preferably from 1 to 15 cm and more preferably from 3 to 6 cm in length. Mineral fiber mats formed from cut mineral fibers are also known to a person skilled in the art by the term chopped strand mat (CSM).

The vinyl ester-ethylene copolymers are obtainable by free-radically initiated polymerization of

a) one or more vinyl esters, and

b) ethylene, and optionally

c) one or more further ethylenically unsaturated monomers.

The vinyl ester-ethylene copolymers preferably have a glass transition temperature Tg in the range from −35 to 40° C., more preferably from −20 to 30° C. and most preferably from −15 to +10° C. Vinyl ester-ethylene copolymers having such glass transition temperatures finally lead to mineral fiber mats having the desired flexibility. The glass transition temperature is controllable inter alia via the level of ethylene in the vinyl ester-ethylene copolymer.

The vinyl ester-ethylene copolymers are preferably from to 130 and more preferably from 30 to 90 in K (determined as per DIN EN ISO 1628-1 on a 1% by weight solution of the particular vinyl ester-ethylene copolymer in a 92:8 (v/v) tetrahydrofuran/water mixture at 23° C.). The K value is frequently also referred to as intrinsic viscosity and is dependent on the molar mass of the copolymer.

The vinyl ester-ethylene copolymers are preferably polymerized using ethylene b) at from 1% to 50% by weight, more preferably at from 5% to 40% by weight and most preferably at from 10% to 30% by weight, all based on the overall mass of all the monomers used to polymerize the vinyl ester-ethylene copolymers.

Suitable vinyl esters a) for the vinyl ester-ethylene copolymers are for example vinyl esters of carboxylic acids having from 1 to 15 carbon atoms. Preferred vinyl esters are vinyl acetate, vinyl propionate, vinyl butyrate, vinyl 2-ethylhexanoate, vinyl laurate, 1-methylvinyl acetate, vinyl pivalate and vinyl esters of alpha-branched monocarboxylic acids having from 5 to 13 carbon atoms, for example VeoVa9R or VeoVa10R (trade names of Shell). Vinyl acetate is particularly preferred.

Vinyl esters a) to polymerize the vinyl ester-ethylene copolymers are preferably used at 50% to 99% by weight, more preferably at 60% to 95% by weight and most preferably at 70% to 90% by weight, all based on the overall mass of all the monomers used to polymerize the vinyl ester-ethylene copolymers.

Useful monomers c) include one or more monomers selected from the group comprising methacrylic esters or acrylic esters of carboxylic acids with branched or unbranched alcohols having from 1 to 15 carbon atoms, methacrylamides or acrylamides of carboxylic acids with branched or unbranched alcohols having from 1 to 15 carbon atoms, ethylenically unsaturated carboxylic acids, ethylenically unsaturated silanes, vinylaromatics, vinyl halides, dienes or olefins other than ethylene.

Preferred methacrylic esters or acrylic esters are methyl acrylate, methyl methacrylate, ethyl acrylate, ethyl methacrylate, propyl acrylate, propyl methacrylate, n-butyl acrylate, n-butyl methacrylate, 2-ethylhexyl acrylate, norbornyl acrylate, hydroxyethyl acrylate. Particular preference is given to methyl acrylate, methyl methacrylate, n-butyl acrylate, hydroxyethyl acrylate and 2-ethylhexyl acrylate.

Preferred methacrylamides or acrylamides are methacrylamide, acrylamide, N-methylolacrylamide, N-methylolmethacrylamide, methyl methylacrylamido-glycolate, acrylamidoacrylic acid and also the esters or alkyl ethers, more particularly isobutoxy ether, of N-methylolacrylamide and of N-methylolmethacrylamide. Particularly preferred methacrylamides or acrylamides are methacrylamide, acrylamide and N-methylol-acrylamide.

Methacrylamides or acrylamides for polymerizing the vinyl ester-ethylene copolymers are preferably used at 0% to 5% by weight, and more preferably at 0% to 1% by weight, all based on the overall mass of all the monomers used to polymerize the vinyl ester-ethylene copolymers.

The ethylenically unsaturated carboxylic acids preferably contain from 3 to 15 carbon atoms and more preferably from 2 to 10 carbon atoms. It is preferable for ethylenically unsaturated mono- or dicarboxylic acids to be concerned, examples being acrylic acid, methacrylic acid, crotonic acid, itaconic acid, fumaric acid, maleic acid. Preferred examples of ethylenically unsaturated carboxylic acids are acrylic acid and methacrylic acid.

Ethylenically unsaturated carboxylic acids for polymerizing the vinyl ester-ethylene copolymers are preferably used at from 0% to 5% by weight and more preferably at from 0% to 2% by weight, all based on the overall mass of all the monomers used to polymerize the vinyl ester-ethylene copolymers.

Preferred ethylenically unsaturated silanes are vinyltri(alkoxy)silanes and γ-acryloyl- or γ-methacryloyloxypropyltri(alkoxy)silanes, α-methacryloyloxymethyltri(alkoxy)silanes, γ-methacryloyloxypropylmethyldi(alkoxy)silanes, vinylalkyldi(alkoxy)silanes, wherein the alkoxy groups may be for example methoxy, ethoxy, methoxyethylene, ethoxyethylene, methoxypropylene glycol ether or ethoxypropylene glycol ether radicals. Examples of preferred ethylenically unsaturated silanes are vinyltrimethoxysilane, vinylmethyldimethoxysilane, vinyltriethoxysilane, vinylmethyldiethoxysilane, vinyltris-(1-methoxy)isopropoxysilane, methacryloyloxypropyltris(2-methoxyethoxy)silane, 3-methacryloyloxypropyltrimethoxysilane, 3-methacryloyloxypropylmethyldimethoxysilane and methacryloyloxymethyltrimethoxysilane.

Ethylenically unsaturated silanes for polymerizing the vinyl ester-ethylene copolymers are preferably used at from 0% to 5% by weight and more preferably at from 0% to 2% by weight, all based on the overall mass of all the monomers used to polymerize the vinyl ester-ethylene copolymers.

Preferred dienes or olefins other than ethylene are propylene and 1,3-butadiene. Preferred vinylaromatics are styrene and vinyltoluene. Vinyl chloride is a preferred vinyl halide.

Optionally, an additional from 0.05% to 5% by weight and preferably from 1% to 2% by weight, based on the total weight of the vinyl ester-ethylene copolymers, of auxiliary monomers can be copolymerized. Examples of auxiliary monomers are ethylenically unsaturated carbonitriles, preferably acrylonitrile; mono- and diesters of fumaric acid and maleic acid such as the diethyl and diisopropyl esters, and also maleic anhydride, ethylenically unsaturated sulfonic acids and salts thereof, preferably vinylsulfonic acid and 2-acrylamido-2-methylpropanesulfonic acid.

Examples of suitable copolymers are copolymers of vinyl acetate with ethylene, copolymers of vinyl acetate with ethylene and one or more further vinyl esters, copolymers of vinyl acetate with ethylene and one or more methacrylamides or acrylamides, copolymers of vinyl acetate with ethylene and one or more further ethylenically unsaturated carboxylic acids, copolymers of vinyl acetate with ethylene and one or more ethylenically unsaturated silanes, copolymers of vinyl acetate with ethylene and one or more methacrylic esters or acrylic esters, copolymers of vinyl acetate with ethylene and vinyl chloride.

Preference is given to copolymers of vinyl acetate with from 1% to 50% by weight of ethylene; copolymers of vinyl acetate with from 1% to 50% by weight of ethylene and from 0% to 5% by weight of one or more monomers from the group of methacrylamides or acrylamides; copolymers of vinyl acetate with from 1 to 50% by weight of ethylene and from 0% to 5% by weight of one or more monomers from the group of ethylenically unsaturated carboxylic acids; copolymers of vinyl acetate with from 1% to 50% by weight of ethylene and from 0% to 5% by weight of one or more monomers from the group of ethylenically unsaturated silanes; wherein the copolymers may each additionally contain the mentioned auxiliary monomers in the mentioned amounts, and the weight % ages sum to 100% by weight in each case.

The choice of monomer and/or the choice of weight fractions for the comonomers results in vinyl ester-ethylene copolymers having the desired glass transition temperature Tg. The glass transition temperature Tg of copolymers can be determined in a known manner using differential scanning calorimetry (DSC). Tg can also be approximated using the Fox equation. According to Fox T. G., Bull. Am. Physics Soc. 1, 3, page 123 (1956), 1/Tg=x1/Tg1+x2/Tg2+ . . . +xn/Tgn, where xn is the mass fraction (% by weight/100) of monomer n and Tgn is the glass transition temperature of the homopolymer of monomer n in kelvins. Tg values for homopolymers are given in the Polymer Handbook 2nd Edition, J. Wiley & Sons, New York (1975).

The vinyl ester-ethylene copolymers are obtained in a conventional manner, for example as described in EP-A 1916275 or EP-A 0959114, using free-radically initiated suspension polymerization or preferably emulsion polymerization in an aqueous medium.

The polymerization is generally carried out in the presence of emulsifiers and/or protective colloids. The protective colloids used here are preferably partially saponified or fully saponified polyvinyl alcohols having a degree of hydrolysis in the range from 80 to 100 and more particularly in the range from 85 to 94 mol % and a Höppler viscosity, in 4% aqueous solution, of 3 to 10 mPas (Höppler method at 20° C., DIN 53015). The protective colloids mentioned are available using methods known to a person skilled in the art, and are generally added in the polymerization in an amount altogether from 1% to 20% by weight, preferably from 1% to 10% by weight and more preferably from 1% to 5% by weight, based on the total weight of the monomers. The use of these low-viscosity polyvinyl alcohols has an advantageous effect, for example, on the solubility of the vinyl ester-ethylene copolymers in the reactive solvents of curable resin compositions.

The aqueous vinyl ester-ethylene copolymer dispersions thus obtainable generally have a solids content in the range from 25% to 70% by weight and preferably in the range from 45% to 65% by weight.

To obtain vinyl ester-ethylene copolymers in the form of water-redispersible polymer powders, the aqueous dispersions of the vinyl ester-ethylene copolymers are dried, for example using spray drying. Spray drying generally utilizes a further added protective colloid as a drying aid. In general, the drying aid (protective colloid) is used in an overall amount of 3% to 30% and preferably 5% to 20% by weight, based on the polymer content of the dispersion.

The mineral fiber mats of the present invention, in addition to the vinyl ester-ethylene copolymers, may contain one or more further polymers based on one or more monomers selected from the group comprising the aforementioned monomers a) and monomers c), as binder(s). These monomers a) and monomers c) are suitably, preferably and more preferably the same monomers a) and monomers c), respectively, as recited in corresponding fashion above.

The binder content of the mineral fiber mats is preferably from 25% to 100% by weight, more preferably from 75% to 100% by weight and most preferably from 90% to 100% by weight of vinyl ester-ethylene copolymers, based on the overall mass of the binders.

The vinyl ester-ethylene copolymer content of the mineral fiber mats is preferably from 1% to 10% by weight, more preferably from 2% to 6% by weight and most preferably from 3% to 5% by weight, based on the overall weight of the mineral fiber mats.

The present invention further provides processes for producing the mineral fiber mats based on mineral fibers and binder, characterized in that at least one vinyl ester-ethylene copolymer is applied as binder to mineral fibers.

The vinyl ester-ethylene copolymers can be used in the form of water-redispersible polymer powders or preferably in the form of aqueous dispersions or aqueous redispersions of water-redispersible polymer powders. The aqueous dispersions or aqueous redispersions preferably have a solids content FG of preferably from 0.5% to 10% by weight and more preferably from 1% to 6% by weight.

To produce mineral fiber mats, the mineral fibers are first generally applied in loose, orderless form to a support surface, for example a moving belt, and the vinyl ester-ethylene copolymers are applied to the mineral fibers by curtain coating or spraying for example. Similarly, the mineral fibers can be fixed between two or more grids of suitable mesh size and dipped into a bath of an aqueous dispersion or aqueous redispersion of the vinyl ester-ethylene copolymers. Subsequently, the mineral fibers thus manipulated are heated to an elevated temperature. Heating is preferably done to ≧100° C., more preferably 120 to 250° C. and most preferably 120 to 180° C., preferably for 1 second to 1 hour and more preferably for 3 s to 10 min. When the vinyl ester-ethylene copolymers are used in the form of aqueous dispersions or aqueous redispersions, a drying operation takes place in this step.

The mineral fiber mats generally contain no or substantially no water. The water content of the mineral fiber mats is preferably ≦1% by weight, more preferably ≦0.5% by weight and most preferably ≦0.3% by weight, based on the overall mass of the mineral fiber mats.

The present invention further provides mineral fiber reinforced plastics structural parts obtainable by curing compositions comprising curable resin compositions and mineral fiber mats based on mineral fibers and binders, characterized in that the mineral fiber mats contain at least one vinyl ester-ethylene copolymer as a binder.

Mineral fiber reinforced plastics structural parts are also known to a person skilled in the art by the term fiber reinforced plastic (FRP).

Curable resin compositions comprise reactive resins and optionally reactive solvents.

Suitable reactive resins are for example unsaturated polyester resins (UP), vinyl ester resins (VE), diallyl phthalate resins (DAP), methacrylate resins or epoxy resins. Preference is given to unsaturated polyester resins, vinyl ester resins or epoxy resins. Unsaturated polyester resins are most preferable.

The compounds recited as monomers a) or monomers b) can be used as reactive solvents. Styrene is preferred.

The curable resin compositions may include the initiator/curative/catalyst additives generally known for this purpose for the curing, for example organic peroxides (Butanox-M50/Akzo-Nobel; MEKP-Härter (145130-X/R&G Faserverbundwerkstoffe) or cobalt(+II) salts (Accelerator NL-49P/Akzo Nobel). Epoxy resins can be accommodated by using the typical amine curatives (Härter EPH 294 (103105-X; R&G Faserverbundwerkstoffe)).

The mineral fiber reinforced plastics structural parts are obtainable using the processes known therefor, for example resin transfer molding (RTM) or structural reaction injection molding (S-RIM), but preferably by the hand lay-up process. In the hand lay-up process, it is preferable to use mineral fiber mats based on cut mineral fibers. In the hand lay-up process, first a thin layer of the curable resin composition is applied to a mold, into which the correspondingly trimmed mineral fiber mats are then pressed. The top surface of the mineral fiber mats, i.e., the surface remote from the mold, then has applied to it, using a roller or a brush for example, one or more layers of the curable resin composition to obtain a laminate layer. Care must be taken here to ensure that the laminate layer is fully snug up against the mold and does not contain any air inclusions. A laminate layer may have one or more further laminate layers applied on top of it in a similar manner. A laminate preferably consists of 5 to 10 laminate layers.

The mineral fiber reinforced plastics structural parts are finally obtained by typically leaving the compositions comprising curable resin compositions and mineral fiber mats for ≧24 hours to cure, preferably at room temperature.

The mineral fiber content of mineral fiber reinforced plastics structural parts is preferably in the range from 5% to 80% by weight and more preferably in the range from 30% to 50% by weight based on the total weight of the mineral fiber reinforced plastics structural part.

The mineral fiber mats of the present invention fulfill the performance criteria required for processing into mineral fiber reinforced plastics structural parts, such as flexibility, moldability or tensile strength. This is achieved through the plasticizer effect of the ethylene units in the vinyl ester-ethylene copolymers of the present invention. This plasticizer effect is also evidenced by the glass transition temperatures Tg of the vinyl ester-ethylene copolymers of the present invention. The vinyl ester-ethylene copolymers have high solubility and a high dissolution rate in the curable compositions. The dissolution rate can be influenced by the K value of the vinyl ester-ethylene copolymers, and is particularly high in the range of the K-value range of the present invention. Furthermore, in ethylene a plasticizing component is used in preparing the binders for the mineral fiber mats of the present invention that is available on economically favorable terms.

The mineral fiber mats of the present invention can be wound up into rolls and hence advantageously transported without the mineral fiber mats sticking to each other. Sticking would make it impossible to unwind the mineral fiber mats from rolls thereof and process them into mineral fiber reinforced plastics structural parts.

The mineral fiber reinforced plastics structural parts obtained according to the present invention have a homogeneous appearance.

Typical fields of use for the mineral fiber mats of the present invention are boat building, automotive construction or aerospace construction and also the manufacture of swimming pools and storage tanks.

The examples which follow further elucidate the invention:

Preparation of Vinyl Ester-Ethylene Copolymers:

Copolymer 1:

A 5 L stirred autoclave was initially charged with 940 g of demineralized water, 583 g of a 9.6% by weight aqueous polyvinyl alcohol solution (commercially available polyvinyl alcohol having a degree of hydrolysis of 88 mol% and a viscosity, in 4% by weight aqueous solution, of 5.5 mPas (Höppler method at 20° C., DIN 53015)), 37 g of a 40% by weight aqueous C13-alkyl ethoxylate solution, 7.7 g of a 20% by weight aqueous dodecylbenzenesulfonate solution, 933 mg of mercaptopropionic acid, 411 mg of sodium formaldehyde sulfoxylate and 7.2 g of a 25% by weight aqueous sodium vinylsulfonate solution to form the initial charge and 372 g of vinyl acetate were emulsified. The emulsion was heated to 45° C. and saturated with ethylene to 47 bar, which corresponds to 309 g of ethylene. Concurrently a 3% by weight aqueous potassium persulfate solution and a 10% by weight aqueous sodium formaldehyde sulfoxylate solution were added at separate locations until the polymerization was initiated (apparent from a rise in temperature and pressure). Then, a mixture of 1490 g of vinyl acetate and 0.93 g of mercaptopropionic acid and also a 3% by weight aqueous potassium persulfate solution (metering rate: 53 ml/h) and a 10% by weight sodium formaldehyde sulfoxide solution (metering rate: 12 ml/h) were added at separate locations over 270 minutes. Thereafter, the aforementioned potassium persulfate and sodium formaldehyde sulfoxylate solutions were added at 1.46 times the metering rate for 70 minutes.

After cooling, depressurizing and adjusting the pH to 4.5 with 10 of a % by weight aqueous NaOH solution, a dispersion was obtained with a solids content of 52.5% by weight, a Tg of 7.7° C. and a K value of 86 (determined to DIN EN ISO 1628-1 at 23° C. on a 1% by weight solution of the vinyl ester-ethylene copolymer in a 92/8 (v/v) tetrahydrofuran/water mixture).

Copolymer 2:

A 5 L stirred autoclave was initially charged with 956 g of demineralized water, 567 g of a 9.9% by weight aqueous polyvinyl alcohol solution (commercially available polyvinyl alcohol having a degree of hydrolysis of 88 mol % and a viscosity, in 4% by weight aqueous solution, of 5.5 mPas (Höppler method at 20° C., DIN 53015)), 26 g of a 40% by weight aqueous C13-alkyl ethoxylate solution, 13.5 g of a 20% by weight aqueous dodecylbenzenesulfonate solution, 935 mg of mercaptopropionic acid, 411 mg of sodium formaldehyde sulfoxylate and 7.2 g of a 25% by weight aqueous sodium vinylsulfonate solution to form the initial charge and 373 g of vinyl acetate were emulsified therein. The emulsion was heated to 45° C. and saturated with ethylene to 47 bar, which corresponds to 309 g of ethylene. Concurrently a 3% by weight aqueous potassium persulfate solution and a 10% by weight aqueous sodium formaldehyde sulfoxylate solution were added at separate locations until the polymerization was initiated (apparent from a rise in temperature and pressure). Then, a mixture of 1500 g of vinyl acetate and 1.87 g of mercaptopropionic acid and also a 3% by weight aqueous potassium persulfate solution (metering rate: 53 ml/h) and a 10% by weight sodium formaldehyde sulfoxide solution (metering rate: 12 ml/h) were added at separate locations over 270 minutes. Thereafter, the aforementioned potassium persulfate and sodium formaldehyde sulfoxylate solutions were added at 1.46 times the metering rate for 70 minutes.

After cooling, depressurizing and adjusting the pH to 4.5 with 10 of a % by weight aqueous NaOH solution, a dispersion was obtained with a solids content of 50.4% by weight, a Tg of 6.6° C. and a K value of 80 (determined to DIN EN ISO 1628-1 at 23° C. on a 1% by weight solution of the vinyl ester-ethylene copolymer in a 92/8 (v/v) tetrahydrofuran/water mixture).

Copolymer 3:

A 5 L stirred autoclave was initially charged with 1100 g of demineralized water, 536 g of a 9.8% by weight aqueous polyvinyl alcohol solution (commercially available polyvinyl alcohol having a degree of hydrolysis of 88 mol % and a viscosity, in 4% by weight aqueous solution, of 5.5 mPas (Höppler method at 20° C., DIN 53015)), 51 g of a 40% by weight aqueous C13-alkyl ethoxylate solution, 26 g of a 20% aqueous dodecyl-benzenesulfonate solution, 1.75 g of mercaptopropionic acid, 385 mg of sodium formaldehyde sulfoxylate and 6.73 g of a 25% by weight aqueous sodium vinylsulfonate solution to form the initial charge and 349 g of vinyl acetate were emulsified therein. The emulsion was heated to 45° C. and saturated with ethylene to ˜47 bar, which corresponds to 309 g of ethylene. Concurrently a 3% by weight aqueous potassium persulfate solution and a 10% by weight aqueous sodium formaldehyde sulfoxylate solution were added at separate locations until the polymerization was initiated (apparent from a rise in temperature and pressure). Then, a mixture of 1490 g of vinyl acetate and 1.86 g of mercaptopropionic acid and also a 3% by weight aqueous potassium persulfate solution (metering rate: 53 ml/h) and a 10% by weight sodium formaldehyde sulfoxide solution (metering rate: 12 ml/h) were added at separate locations over 270 minutes. Thereafter, the aforementioned potassium persulfate and sodium formaldehyde sulfoxylate solutions were added at 1.46 times the metering rate for 70 minutes.

After cooling, depressurizing and adjusting the pH to 4.5 with 10 of a % by weight aqueous NaOH solution, a dispersion was obtained with a solids content of 51.3% by weight, a Tg of −9° C. and a K value of 44 (determined to DIN EN ISO 1628-1 at 23° C. on a 1% by weight solution of the vinyl ester-ethylene copolymer in a 92/8 (v/v) tetrahydrofuran/water mixture).

Copolymer 4:

A 5 L stirred autoclave was initially charged with 936 g of demineralized water, 560.5 g of a 10% by weight aqueous polyvinyl alcohol solution (commercially available polyvinyl alcohol having a degree of hydrolysis of 88 mol % and a viscosity, in 4% by weight aqueous solution, of 5.5 mPas (Höppler method at 20° C., DIN 53015)), 65.4 g of a 20% aqueous dodecyl-benzenesulfonate solution, 934 mg of mercaptopropionic acid, 411 mg of sodium formaldehyde sulfoxylate and 7.2 g of a 25% by weight aqueous sodium vinylsulfonate solution to form the initial charge and 372 g of vinyl acetate were emulsified therein. The emulsion was heated to 45° C. and saturated with ethylene to 47 bar, which corresponds to 309 g of ethylene. Concurrently a 3% by weight aqueous potassium persulfate solution and a 10% by weight aqueous sodium formaldehyde sulfoxylate solution were added at separate locations until the polymerization was initiated (apparent from a rise in temperature and pressure). Then, a mixture of 1500 g of vinyl acetate and 3.74 g of mercaptopropionic acid and also a 3% by weight aqueous potassium persulfate solution (metering rate: 53 ml/h) and a 10% by weight sodium formaldehyde sulfoxide solution (metering rate: 12 ml/h) were added at separate locations over 270 minutes. Thereafter, the aforementioned potassium persulfate and sodium formaldehyde sulfoxylate solutions were added at 1.46 times the metering rate for 70 minutes.

After cooling, depressurizing and adjusting the pH to 4.5 with 10 of a % by weight aqueous NaOH solution, a dispersion was obtained with a solids content of 50.1% by weight, a Tg of 7.6° C. and a K value of 52.6 (determined to DIN EN ISO 1628-1 at 23° C. on a 1% by weight solution of the vinyl ester-ethylene copolymer in a 92/8 (v/v) tetrahydrofuran/water mixture).

Production of Mineral Fiber Mats

62 g of glass fibers were uniformly distributed between two grids each having an area of 44 cm×40 cm and mesh sizes of 2 mm. The grids plus the mineral fibers were completely immersed for 15 seconds in a 2% by weight aqueous dispersion of the particular binder. Subsequently, the grids together with the mineral fibers were removed from the aqueous dispersion and the excess aqueous dispersion of the particular binder was allowed to drip off by keeping the grids horizontally suspended in air at room temperature for 4 min. After a subsequent drying for 4 min at 150° C. in an oven (from Werner Matthis AG, type LTF, 51576), the grids were removed to free the mineral fiber mat.

The mineral fiber mat thus obtained had a base area of 35 cm×40 cm, a height of 1 to 2 mm, a basis weight of 450±10 g/m², a water content of ≦0.3% by weight, based on the overall mass of the particular mineral fiber mat, and also a content of the particular vinyl ester-ethylene copolymer corresponding to that reported in table 1 (the reported values were determined as per EN29073 Part 2).

Performance Testing of Mineral Fiber Mats

The test results are given in table 1.

Solubility of mineral fiber mats in styrene:

The solubility of the particular mineral fiber mat in styrene was determined to ISO 2558 at 23° C.

Solubility here is characterized by the time needed to disintegrate the textile fabric of the mineral fiber mat, i.e., to dissolve the binder of the mineral fiber mat.

Ultimate tensile strength of mineral fiber mats (UTS): The ultimate tensile strength of the particular mineral fiber mat was determined with a tensile tester (Zwick 1445) to DIN EN ISO 527 Parts 1 to 3.

Clamped length was 150 mm, sample width was 100 mm, and the pre-tensioning force was 0.1 N, and the measurement was carried out using an extension rate of 200 mm/min.

Blocking test of mineral fiber mats: test for blocking/sticking of mineral fiber mats in storage:

The particular mineral fiber mat was cut to cut out 3 test specimens each time, each having a base area of 6 cm×8 cm, which were placed on top of each other with the base areas to form a stack. The stack was placed between two glass plates so that the base areas of the stack were completely covered by the two glass plates to form a pressable body.

The pressable body was placed with one of its glass plates on solid ground, a weight of 3.8 kg was applied centrally, heated to 40° C. and stored at 40° C. for 24 h. After cooling down to room temperature, the weight and the glass plates were removed. An attempt was made to separate the individual test specimens from each other by hand.

Assessment:

1 The stack fragments by itself into the three test specimens; i.e., the test specimens do not adhere to each other.

2. The stack is readily separated into the three test specimens, although there is a slight noise. But the surface of the test specimens is not damaged. That is, there is a very low level of adherence between the test specimens in the stacks.

3. The stack is scarcely separable into test specimens. Any attempt at separation causes the surface of the test specimens to become damaged. That is, the test specimens adhere to each other appreciably.

4. The stack cannot be separated into test specimens without completely damaging the surface of the individual test specimens; that is, the adherence between the test specimens in the stack is stronger than the adherence of the mineral fibers within a test specimen.

Bull's eye test:

The bull's eye test was carried out according to ISO TR3717-1975 (Textile glass-Mats and woven fabrics—Determination of wet-out time by resin).

The particular mineral fiber mat was placed on a glass plate above a bull's eye, and weighted with a metal ring. The imprint on the bull's eye was completely covered by the mineral fiber mat and was no longer visible.

Then, the particular curable resin composition was poured onto the particular mineral fiber mat and the time was taken for the imprint on the bull's eye to become readily visible again, i.e., until the mineral fiber mat thus treated became transparent.

TABLE 1
Results of performance testing of mineral fiber mats:

| | | | | | | | Bull's eye test^{c} | |
|---|---|---|---|---|---|---|---|---|
| | | | | | | Styrene | Norsodyne | Polylite |
| | Binder of mineral | | Hand | Blocking | UTS^{a} | solubility^{b} | H13239^{d} | 440-M850^{e} |
| Example | fiber mat | | feelⁱ | test | [N/mm²] | [s] | [s] | [s] |
| comp. 1 | Vinamul 8838^{f} | (4.1)^{h} | soft | 1 | 2.0 | 5 | 208 | 205 |
| comp. 2 | Vinamul 8839^{g} | (4.2)^{h} | very | 1 | 1.2 | 3 | 295 | 206 |
| | | | soft | | | | | |
| inv. 3 | copolymer 1 | (4.2)^{h} | soft | 1 | 1.0 | 3 | 229 | 124 |
| inv. 4 | copolymer 2 | (4.8)^{h} | soft | 1 | 1.3 | 4 | 251 | 254 |
| inv. 5 | copolymer 3 | (4.1)^{h} | very | 2 | 0.6 | 3 | 99 | 74 |
| | | | soft | | | | | |
| inv. 6 | copolymer 4 | (4.6)^{h} | soft- | 2 | 1.1 | 3 | 386 | 165 |
| | | | hard | | | | | |

^{a}standardized to 450 g/m² basis weight;
^{b}standardized to 1 mm thickness of mineral fiber mat;
^{c}standardized to 1 mm thickness of mineral fiber mat;
^{d}polyester resin (trade name of Cray Valley);
^{e}polyester resin (trade name of Reichhold);
^{f}polyvinyl acetate homopolymer with plasticizer content (Vinamul 8838 from Celanese);
^{g}polyvinyl acetate homopolymer with plasticizer content (Vinamul 8839 from Celanese);
^{h}proportion in % by weight the particular binder contributes to the mineral fiber mat, based on the overall mass of the particular mineral fiber mat.
ⁱqualitative assessment of flexibility/softness based on hand feel of mineral fiber mat. Mineral fiber mats should be very soft to soft for good processability.

The performance testing of the mineral fiber mats reveals that the inventive mineral fiber mats (table 1: inv. examples 3 to 6) achieve the performance characteristics of common mineral fiber mats (table 1: comp. examples 1 and 2).

Advantageously, however, unlike the common mineral fiber mats, the inventive mineral fiber mats do not contain any plasticizers.

Production of Mineral Fiber Reinforced Plastics Structural Parts:

### Example 7

The present example utilized altogether a curable resin composition containing 16.07 g of a polyester-styrene resin mixture and 0.273 ml of Butanox M-50 initiator (from Akzo-Nobel) and 0.07 ml of Accelerator NL49P catalyst (from Akzo-Nobel).

The mineral fiber mat of example 4 was cut to cut out 5 pieces of 7 cm×8 cm base area (CSM piece). The 5 CSM pieces together weighed 10.71 g.

A self-supporting polyethylene terephthalate polyester film treated with PVA film release agent (from R&G) had applied to it, over an area of 7 cm×8 cm, using a brush, a small amount of the curable resin composition, and the first CSM piece was placed on top.

A brush was used to apply some of the curable resin composition to this CSM piece so that the mineral fiber mat became saturated by the curable resin composition. The CSM piece thus treated had a further CSM piece placed on top of it. The further 3 CSM pieces were applied in a similar manner. The last CSM piece applied, the fifth CSM piece, was covered with a self-supporting polyethylene terephthalate polyester film which was again treated with PVA film release agent (from R&G) and consolidated with a Teflon roller without any curable resin composition being pressed out of the laminate. The laminate thus obtained was cured at room temperature for 24 h.

The polyethylene terephthalate polyester films were peeled off to leave a homogeneous mineral fiber reinforced plastics structural part in which no large inclusions such as, for example, air bubbles or mineral fiber bundles were visible.

The proportion of mineral fibers was 40% by weight, based on the overall mass of the mineral fiber reinforced plastics structural part.

1. A mineral fiber reinforced plastics structural part obtainable by curing compositions comprising mineral fiber mats based on mineral fibers and one or more binders and curable resin compositions containing reactive resins selected from the group consisting of unsaturated polyester resins, vinyl ester resins, diallyl phthalate resins and methacrylate resins and optionally reactive solvents,
wherein the mineral fiber mats contain as binder at least one vinyl ester-ethylene copolymer obtainable by free-radically initiated polymerization of
a) one or more vinyl esters, and
b) ethylene, and optionally
c) one or more further ethylenically unsaturated monomers selected from the group consisting of methacrylic esters or acrylic esters of carboxylic acids with branched or unbranched alcohols having from 1 to 15 carbon atoms, ethylenically unsaturated carboxylic acids, vinylaromatics, vinyl halides, dienes and olefins other than ethylene.

2. The mineral fiber reinforced plastics structural part according to claim 1, wherein the reactive solvent is styrene.

3. The mineral fiber reinforced plastics structural part according to claim 1, wherein the mineral fiber mat is from 0.5 to 5 mm in thickness as determined per EN 29073 Part 2.

4. The mineral fiber reinforced plastics structural part according to claim 1 wherein glass fibers are used as mineral fibers.

5. The mineral fiber reinforced plastics structural part according to claim 1 wherein the vinyl ester-ethylene copolymers have a glass transition temperature Tg in the range from −35° C. to 40° C.

6. The mineral fiber reinforced plastics structural part according to claim 1 wherein the vinyl ester-ethylene copolymers are from 20 to 130 in K as determined per DIN EN ISO 1628-1 on a 1% by weight solution of the particular vinyl ester-ethylene copolymer in a 92:8 (v/v) tetrahydrofuran/water mixture at 23° C.

7. The mineral fiber reinforced plastics structural part according to claim 1 wherein the polymerization of the vinyl ester-ethylene copolymers utilizes from 1% to 50% by weight of ethylene, based on the overall mass of all the monomers used for polymerizing the vinyl ester-ethylene copolymers.
